(19) United States
(12) Patent Application Publication
(10) Pub. No.: US 2014/0181429 A1
(43) Pub. Date: Jun. 26, 2014

(54) MULTI-DIMENSIONAL HARDWARE DATA TRAINING BETWEEN MEMORY CONTROLLER AND MEMORY

(71) Applicant: NVIDIA CORPORATION, Santa Clara, CA (US)

(72) Inventors: Venkata Ramana Malladi, San Jose, CA (US); Tony Yuhsiang Cheng, Union City, CA (US); Ambuj Kumar, Sunnyvale, CA (US); Brian Keith Langendorf, Benicia, CA (US)

(73) Assignee: NVIDIA CORPORATION, Santa Clara, CA (US)

(21) Appl. No.: 13/727,333

(22) Filed: Dec. 26, 2012

(51) Int. Cl. G06F 12/00

(52) U.S. Cl. CPC G06F 12/00
USPC 711/154

(57) ABSTRACT

A method of training a memory interface between a memory controller and a memory module. The method includes programming a delay line of a data strobe with a delay value and programming a reference voltage with a voltage value. The method then writes a data bit pattern to the memory module wherein the data bit pattern is of a first plurality of unique data bit patterns. The data bit pattern is read back and a result is compared with the data bit pattern. A determination is made whether the memory module is in a pass state or an error state based on the comparing. The steps are repeated with another data bit pattern of the first plurality of data bit patterns. The method is repeated for each combination of the data strobe delay value and the reference voltage value.

### CROSS-REFERENCE TO RELATED APPLICATIONS

This application is related to patent applications: “HARDWARE COMMAND TRAINING FOR MEMORY USING WRITE LEVELING MECHANISM,” concurrently filed with this application, with attorney docket number NVID-P-SC-10-0133-US1; “HARDWARE CHIP SELECT TRAINING FOR MEMORY USING WRITE LEVELING MECHANISM,” concurrently filed with this application, with attorney docket number NVID-P-SC-10-0135-US1; “HARDWARE COMMAND TRAINING FOR MEMORY USING READ COMMANDS,” concurrently filed with this application, with attorney docket number NVID-P-SC-10-0136-US1; “METHOD AND SYSTEM FOR CHANGING BUS DIRECTION IN DDR MEMORY SYSTEMS,” concurrently filed with this application, with attorney docket number NVID-P-SC-10-0127-US1; and “HARDWARE CHIP SELECT TRAINING FOR MEMORY USING READ COMMANDS,” concurrently filed with this application, with attorney docket number NVID-P-SC-10-0134-US1, which are all herein incorporated by reference in their entirety.

### BACKGROUND OF THE INVENTION

In memory interface qualification and validation, proper timing between a memory controller and DRAM chips is established for operation. The memory controller ensures that the skew between data strobe and data meet setup and hold time tolerances at the DRAM chip. The skew between data strobe and data and the voltage swing of data may vary a lot resulting in a reduced data strobe/data eye. The memory controller samples data signals using the data strobe signal and therefore the data strobe signal must be delayed and positioned with respect to data signals in order to achieve an acceptable timing margin. Additionally, the variable voltage swing on the data signal must be compensated for. This may be accounted for with a variable voltage reference that is compared against the data voltage. As such, a rectangular region having acceptable data strobe delay and variable voltage reference values must be found. A final chosen data strobe delay and variable voltage reference value may be placed in the center of this rectangular region.

Current methods to train memory interfaces and determine this rectangular region are achieved characterizing the chip using the help of software as part of the silicon bring-up phase. However, the current methodology is time consuming as the software algorithm is slow and must repeat the calculations for each and every board type and memory configuration type across the entire silicon process. The current methodology is also error prone as it involves interaction of various tools, software and manual interpretation of results. Further, all the tools need to be set up and loaded with the proper constraints and the process must be repeated for every possible board type and every possible memory configuration. Finally, the methodology is not ideal because as the frequency of DRAM increases, the available command signal and clock eye width decreases making it increasingly difficult to obtain a common skew compensation across the entire silicon process range.

### BRIEF SUMMARY OF THE INVENTION

Accordingly, a need exists for a method and system of automatic hardware based memory interface training. Embodiments of the present invention disclose a method and system for automatically training the memory interface by performing a two dimensional training between the data voltage reference value and the data strobe delay element for memory devices, e.g. DDR3 compatible devices in one embodiment.

More specifically, embodiments of the present invention are directed towards a method of a memory interface between a memory controller and a memory module. The method includes programming a delay line of a data strobe with a delay value and programming a reference voltage with a voltage value. The method then writes a data bit pattern to the memory module wherein the data bit pattern is of a first plurality of unique data bit patterns. The data bit pattern is read back and a result thereof is compared with the data bit pattern. A determination is made whether the memory module is in a pass state or an error state based on the comparing. The steps are repeated with another data bit pattern of the first plurality of data bit patterns. The method is repeated for each combination of the data strobe delay value and the reference voltage value.

In another embodiment, the present invention is drawn to a computer readable storage medium having stored thereon, computer executable instructions that, if executed by a computer system cause the computer system to perform a method of a memory interface between a memory controller and a memory module. The method includes programming a delay line of a data strobe with a delay value and programming a reference voltage with a voltage value. The method then writes a data bit pattern to the memory module wherein the data bit pattern is of a first plurality of unique data bit patterns. The data bit pattern is read back and a result thereof is compared with the data bit pattern. A determination is made whether the memory module is in a pass state or an error state based on the comparing. The steps are repeated with another data bit pattern of the first plurality of data bit patterns. The method is repeated for each combination of the data strobe delay value and the reference voltage value.

In yet another embodiment, the present invention is drawn to a system. The system comprises a processor coupled to a computer readable storage media using a bus and executing computer readable code which causes the computer system to perform a method of a memory interface between a memory controller and a memory module. The method includes programming a memory controller into a mode wherein a column access strobe is active for a single clock cycle. The method includes programming a delay line of a data strobe with a delay value and programming a reference voltage with a voltage value. The method then writes a data bit pattern to the memory module wherein the data bit pattern is of a first plurality of unique data bit patterns. The data bit pattern is read back and a result thereof is compared with the data bit pattern. A determination is made whether the memory module is in a pass state or an error state based on the comparing. The steps are repeated with another data bit pattern of the first plurality of data bit patterns. The method is repeated for each combination of the data strobe delay value and the reference voltage value.

### BRIEF DESCRIPTION OF THE DRAWINGS

The embodiments of the present invention are illustrated by way of example, and not by way of limitation, in the figures of the accompanying drawings and in which like reference numerals refer to similar elements.

FIG. 1 shows an exemplary computer system, in accordance with one embodiment of the present invention.

FIG. 2 shows an exemplary memory controller comprising a plurality of signal outputs, in accordance with one embodiment of the present invention.

FIG. 3 shows an exemplary memory module comprising a plurality of signal inputs and a plurality of signal outputs, in accordance with one embodiment of the present invention.

FIG. 4 depicts a flowchart of an exemplary computer controlled process of training a memory interface, in accordance with one embodiment of the present invention.

FIG. 5 shows a two-dimensional graph depicting a passing region of reference voltage values and data strobe delay values as a result of shmooing, in accordance with one embodiment of the present invention.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

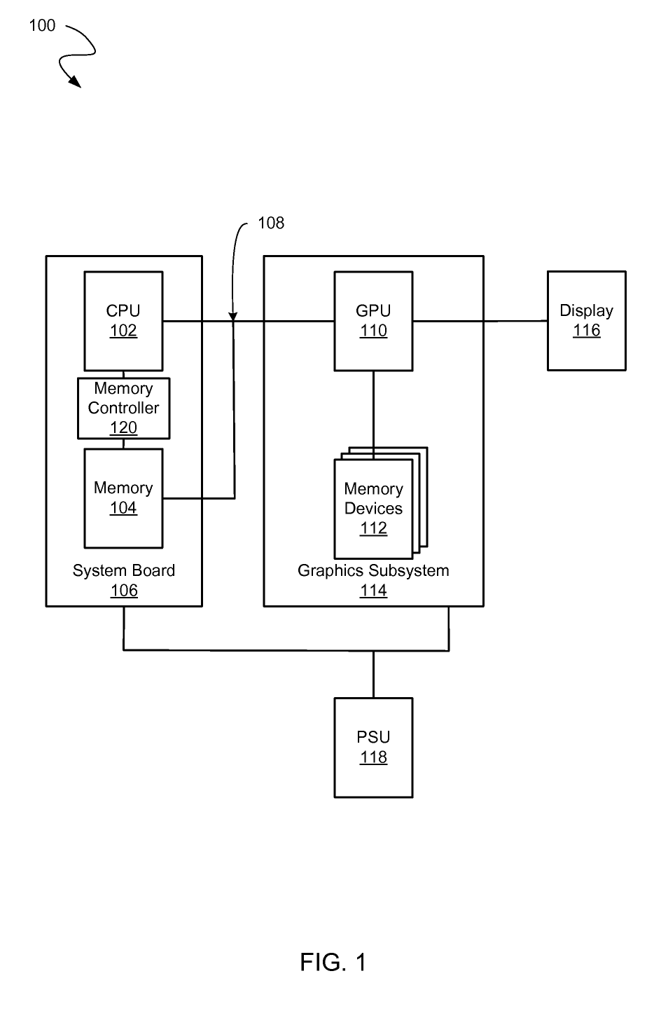

FIG. 1 shows an exemplary computer system 100 in accordance with one embodiment of the present invention. Computer system 100 depicts the components in accordance with embodiments of the present invention providing the execution platform for certain hardware-based and software-based functionality, in particular, computer graphics rendering and display capability. In general, computer system 100 comprises a system board 106 including at least one central processing unit (CPU) 102 and a system memory 104. The CPU 102 can be coupled to the system memory 104 via a memory controller 120 or can be directly coupled to the system memory 104 via a memory controller internal (not shown) to the CPU 102. In an embodiment, system memory 104 may be DDR3 SDRAM.

Computer system 100 also comprises a graphics subsystem 114 including at least one graphics processor unit (GPU) 110. For example, the graphics subsystem 114 may be included on a graphics card. The graphics subsystem 114 may be coupled to a display 116. One or more additional GPU(s) 110 can optionally be coupled to computer system 100 to further increase its computational power. The GPU(s) 110 may be coupled to the CPU 102 and the system memory 104 via a communication bus 108. The GPU 110 can be implemented as a discrete component, a discrete graphics card designed to couple to the computer system 100 via a connector (e.g., AGP slot, PCI-Express slot, etc.), a discrete integrated circuit die (e.g., mounted directly on a motherboard), or as an integrated GPU included within the integrated circuit die of a computer system chipset component (not shown). Additionally, memory devices 112 may be coupled with the GPU 110 for high bandwidth graphics data storage, e.g., the frame buffer. In an embodiment, the memory devices 112 may be dynamic random-access memory. A power source unit (PSU) 118 may provide electrical power to the system board 106 and graphics subsystem 114.

The CPU 102 and the GPU 110 can also be integrated into a single integrated circuit die and the CPU and GPU may share various resources, such as instruction logic, buffers, functional units and so on, or separate resources may be provided for graphics and general-purpose operations. The GPU may further be integrated into a core logic component. Accordingly, any or all the circuits and/or functionality described herein as being associated with the GPU 110 can also be implemented in, and performed by, a suitably equipped CPU 102. Additionally, while embodiments herein may make reference to a GPU, it should be noted that the described circuits and/or functionality can also be implemented and other types of processors (e.g., general purpose or other special-purpose coprocessors) or within a CPU.

System 100 can be implemented as, for example, a desktop computer system or server computer system having a powerful general-purpose CPU 102 coupled to a dedicated graphics rendering GPU 110. In such an embodiment, components can be included that add peripheral buses, specialized audio/video components, IO devices, and the like. Similarly, system 100 can be implemented as a portable device (e.g., cellphone, PDA, etc.), direct broadcast satellite (DBS)/terrestrial set-top box or a set-top video game console device such as, for example, the Xbox®, available from Microsoft Corporation of Redmond, Wash., or the PlayStation3®, available from Sony Computer Entertainment Corporation of Tokyo, Japan. System 100 can also be implemented as a “system on a chip”, where the electronics (e.g., the components 102, 104, 110, 112, and the like) of a computing device are wholly contained within a single integrated circuit die. Examples include a hand-held instrument with a display, a car navigation system, a portable entertainment system, and the like.

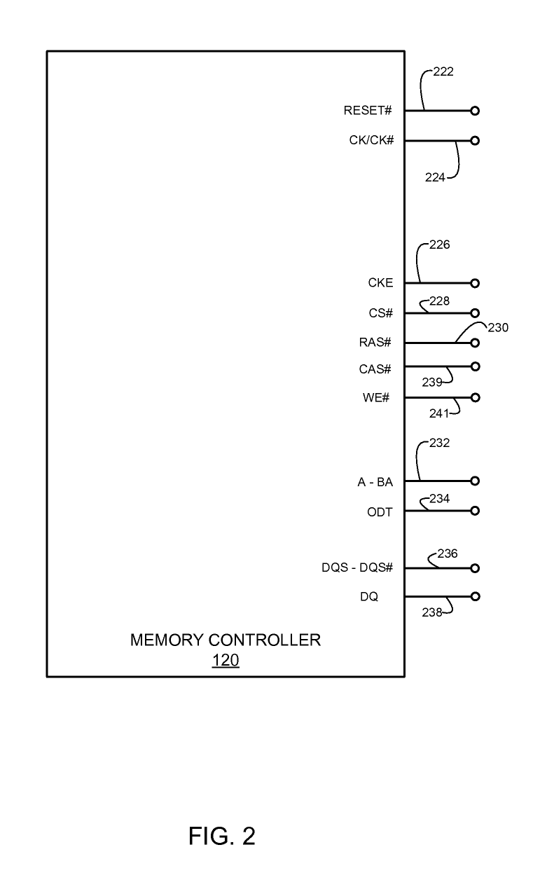

FIG. 2 shows an exemplary memory controller 120 comprising a plurality of signal outputs, in accordance with one embodiment of the present invention. Memory controller 120 is a digital circuit in one embodiment operable to manage the flow of data going to and from memory module 104 (FIG. 1). Memory controller 120 includes logic necessary to read and write to memory module 104 (FIG. 1) and to refresh memory module 104 (FIG. 1) by sending current through the entire device.

In one example, memory controller 120 includes output signals consistent with the JEDEC DDR3 SDRAM Specification. The output signals are sent to memory module 104 (FIG. 1). These output signals include RESET#222, CK/CK#224, CKE 226, CS#228, RAS#230, CAS#239, WE#241, A-BA 232 and ODT 234. RESET#222 is an active low asynchronous reset operable to reset memory module 104 (FIG. 1). CK/CK#224 is a differential clock signal operable to clock memory module 104 (FIG. 1). CKE 226 is a clock enable signal operable for instructing memory module 104 (FIG. 1) to acknowledge clock transitions. CS#228 is a chip select signal operable for rank (not shown) selection on memory module 104 (FIG. 1). RAS#230, CAS#239 and WE#241 are command outputs to memory module 104 (FIG. 1) that define the command being entered. RAS#230 is a row access strobe to retrieve data from memory module 104 (FIG. 1). CAS#239 is a column access strobe to retrieve data from memory module 104 (FIG. 1). WE#241 is a write enable signal operable for instructing memory module 104 (FIG. 1) to acknowledge write instructions. A-BA 232 are address outputs and bank address outputs respectively. The address outputs provide the row address for active commands and column address for read/write commands to select one location out of the memory array in a respective bank (not shown) of memory module 104 (FIG. 1). Address outputs also provide the op-code during Mode Register Set (MRS) commands to memory module 104 (FIG. 1). The bank address outputs define to which bank (not shown) of memory module 104 (FIG. 1) an active read, write or precharge command is being applied. Bank address also determines which mode register of memory module 104 (FIG. 1) is to be accessed during a MRS cycle. ODT 234 is on die termination output and enables termination resistance internal to the memory module 104 (FIG. 1).

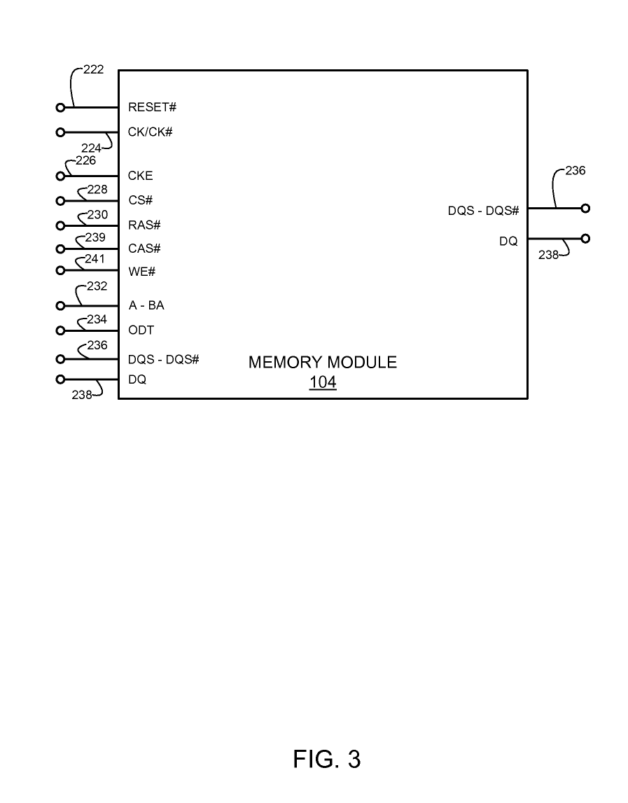

Memory controller 120 also includes bidirectional signals DQS-DQS#236 and DQ 238 (both described in FIG. 3).

It is appreciated that embodiments of the present invention enable the hardware within computer system 100 (FIG. 1) to automatically perform a two-dimensional memory interface training between the data bus reference voltage (IVREF) (not shown) and a data strobe delay element (DLCELL) (not shown). The memory interface includes, but is no limited to, memory controller 120 and memory module 104 (FIG. 1). Training of the memory interface is accomplished using memory controller 120 to write cache-lines of data and reading back and comparing the data for every combination of DLCELL and IVREF and determining which DLCELL and IVREF combinations result in a passing setting. Each cache line data consists of a victim bit and various aggressor bits. The data bit patterns are generated such that intersymbol interference and cross talk effects (simultaneous switching output) are introduced within the memory interface.

Advantageously, embodiments of the present invention provide for a method to train a memory interface. Often times, there may be a high variance in the skew between data strobe 236, data 238, and the voltage swing of data 238. As a result, there may be a reduced data strobe/data eye. In addition, the skew between data strobe 236 and data 238 and the reduction in the voltage swing of data 238 change dynamically as activity increases on a printed circuit board due to increased inter-symbol interference. This variance may be attributed to silicon speed grade, packaging, or board signal integrity issues. Since the memory module 104 (FIG. 1) is synchronous, the memory controller 120 must assure that the command signals meet setup and hold time requirements at the memory module 104 (FIG. 1). In an embodiment, the chip select signal 228 may be associated with a programmable delay line (not shown) operable to delay CAS#239 (the particular command signal used for training).

Memory interface training is typically a part of memory qualification and validation procedures. Embodiments of the present invention issue read and write commands to perform the memory interface training. Additionally, embodiments of the present invention enable multidimensional training which provides for a better understanding of the passing eye, i.e. a better picture of passing data bus reference voltage (IVREF) and a data strobe delay element (DLCELL) settings.

Memory controller 120 supports a mechanism to reset the memory module 104 (FIG. 1) via the RESET#signal 222. During memory interface training, it is possible to place the memory module 104 in a bad state if the setup and hold times are violated. In an embodiment, the chip memory module 104 (FIG. 1) is reset via the RESET#signal 222 after every memory interface training iteration.

FIG. 3 shows an exemplary memory module 104 comprising a plurality of signal inputs and a plurality of signal outputs, in accordance with one embodiment of the present invention. In an embodiment, memory module 104 is a double data rate type three synchronous dynamic random access memory (DDR3 SDRAM). Memory module 104 receives the same signals output from memory controller 120 (FIG. 2) as input signals. These signals include RESET#222, CK/CK#224, CKE 226, CS#228, RAS#230, CAS#239, WE#241, A-BA 232 and ODT 234, all described above in FIG. 2. In addition, memory module 104 includes bidirectional signals DQS-DQS#236 and DQ-DM#238.

DQS-DQS#236 is the data strobe signal that is output with read data and is input with write data. The data strobe is edge-aligned with read data and centered with write data. DQ 238 is the bi-directional data bus wherein data is transmitted over the respective bus.

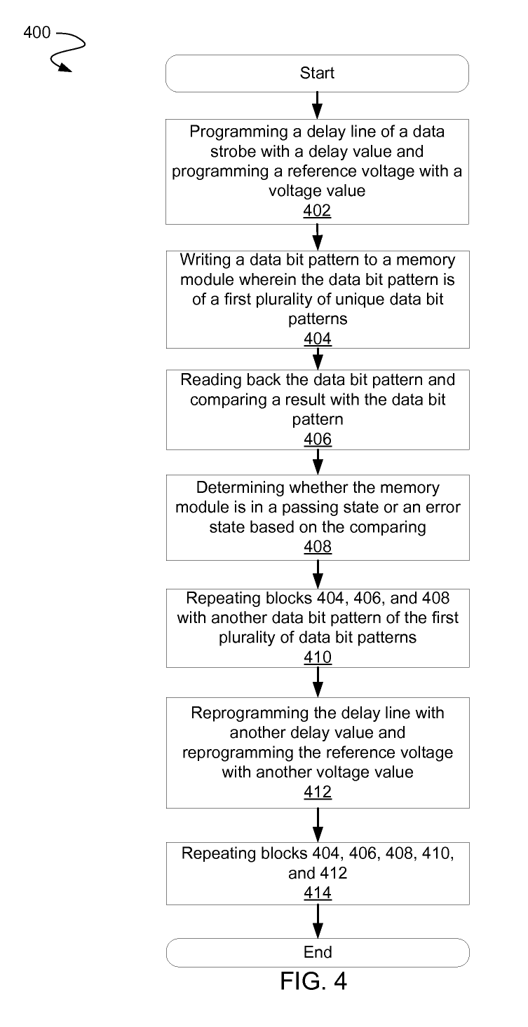

FIG. 4 depicts a flowchart 400 of an exemplary computer controlled process of training a memory interface, in accordance with one embodiment of the present invention. The computer-controlled process of flowchart 400 may be implemented on the system of FIG. 1. In block 402, a delay line of a data strobe is programmed with a delay value (DLCELL) and a reference voltage is programmed with a voltage value (IVREF). In an embodiment, DLCELL is PVT (process, voltage, and temperature) invariant and allows for delaying the data strobe with respect to the data.

In block 404, a data bit pattern is written to a memory module wherein the data bit pattern is of a first plurality of unique data bit patterns. In an embodiment, the unique data bit patterns are generated using a linear feedback shift register (LFSR) implemented within hardware. The data bit patterns are written to the memory module by the memory controller. Each data bit pattern comprises a victim bit and a plurality of aggressor bits in order to introduce intersymbol interference and cross talk effects (simultaneous switching output). In an embodiment, within each byte, the victim bit is programmable and different data bit patterns can consider different bits as victim bits. Any one of eight bits in a byte can be the “worst case” bit with respect to intersymbol interference.

In block 406, the data bit pattern is read back and a result is compared with the data bit pattern. The resulting data returned upon the read operation is compared with the originally written data bit pattern.

In block 408, a determination is made whether the memory module is in a passing state or an error state based on the comparing. The memory module is in a passing state if the resulting data returned upon the read operation is equivalent to the originally written data bit pattern. The memory module is in an error state if the resulting data returned upon the read operation is not equivalent to the originally written data bit pattern. In an embodiment, the memory module states are stored in a result matrix indicating a passing or failing state for the combination of DLCELL and IVREF for the particular data bit pattern.

In block 410, blocks 404, 406, and 408 are repeated with another data bit pattern of the first plurality of data bit patterns. Another data bit pattern, different from the first written data bit pattern, is written to the memory module, read back and compared with what was written, and a determination is made whether the memory module is in a passing state or an error state. The data bit pattern written in this step has a different victim bit than the data bit pattern written in block 404. Block 410 is repeated until all of the data bit patterns of the first plurality of data bit patterns are written to the memory module, read back and compared. In an embodiment, the first plurality of data bit patterns may comprise 32 data bit patterns. In another embodiment, a second plurality of data bit patterns may comprise 256 data bit patterns.

In block 412, the delay line is reprogrammed with another delay value and the reference voltage is reprogrammed with another voltage value. DLCELL is reprogrammed with another delay value and IVREF is reprogrammed with another voltage value.

In block 414, blocks 404, 406, 408, 410, and 412 are repeated with the new delay value and voltage value. Block 414 is repeated until each combination of DLCELL and IVREF are tested with each data bit pattern of the first plurality of data bit patterns. In an embodiment, a result matrix is formed indicating pass states and error states for every combination of DLCELL and IVREF. The result matrix shows the pass state and error state of each data bit pattern with respect to each combination of DLCELL and IVREF. These range of values represent the acceptable DLCELL and IVREF values to ensure proper function of the memory module.

In am embodiment, the first plurality of data bit patterns comprises a subset of every possible data bit pattern in a second plurality of data bit patterns, e.g. 32 data bit patterns of a possible 256 data bit patterns. Initially, the DLCELL and IVREF testing may be performed non-exhaustively using the first plurality (subset) of data bit patterns. Once all combinations of DLCELL and IVREF are tested using the first plurality of data bit patterns, the result matrix is processed to determine the midpoint of the passing region. The DLCELL value having the maximum contiguous IVREF passing region is chosen. The midpoint of this IVREF region and the DLCELL value form one of two valid points for the midpoint of the passing region. Next, the IVREF value having the maximum contiguous DLCELL passing region is chosen. The midpoint of this DLCELL region and the IVREF value form the other valid point for the midpoint of the passing region. Both the points are analyzed and the point satisfying a rectangular margin requirement of IVREF and DLCELL is chosen.

In an embodiment, a comprehensive testing region is established around the midpoint. An exhaustive test using all possible data bit patterns contained within the second plurality of data bit patterns, e.g. 256, is performed within the comprehensive testing region to determine if the rectangular passing region exists or not. If any of the points within the comprehensive testing region and its corresponding rectangle region passes the exhaustive test, that point is chosen is that the final DLCELL and IVREF values and the memory interface training is complete.

In another embodiment, if the memory module is determined to be in an error state, the memory module is reset via the #RESET signal. Once the memory module is reset, the next iteration of training may continue.

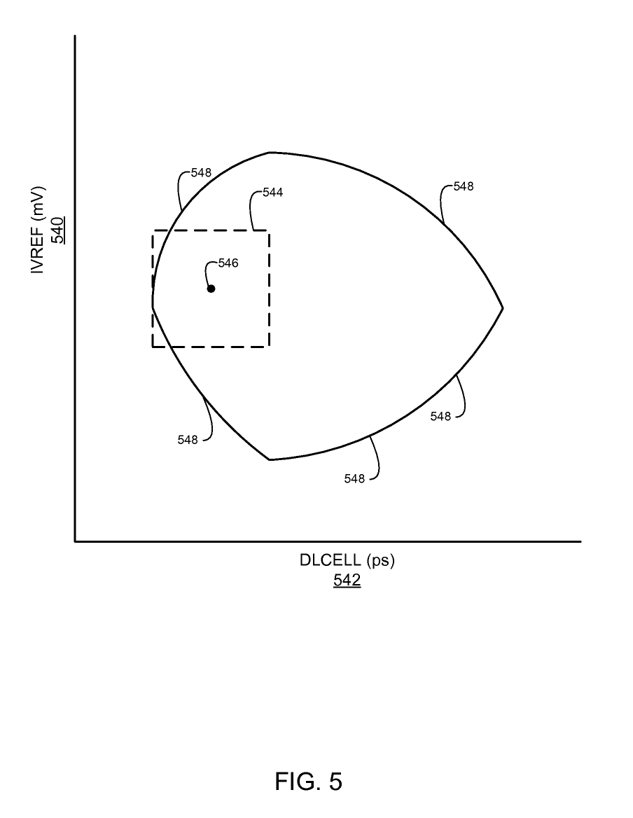

FIG. 5 shows a two-dimensional graph 500 depicting a passing region of reference voltage 540 values and data strobe delay 542 values as a result of shmooing, in accordance with one embodiment of the present invention. Shmooing means running testing for memory interface training with every value of each parameter (e.g. DLCELL and IVREF). Graph points 548 represent the different tested values of DLCELL and IVREF. DLCELL may be represented in units of picoseconds and IVREF may be represented in units of millivolts. Among those graph points 548 that represent passing data values, a midpoint 546 of the passing region is established based on the method described above. A rectangular window 544 established based on the non-exhaustive testing is established based on the midpoint 546, as mentioned above. The rectangular window effectively becomes the exhaustive testing region. Comprehensive testing is performed on the exhaustive testing region using the second plurality of data bit patterns (all possible combinations of data bit patterns) as described above. A final DLCELL and IVREF value are chosen based on the comprehensive testing. In an embodiment, the two-dimensional graph 500 may be represented as a data structure stored within memory on the system of FIG. 1.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

What is claimed is:

1. A method of training a memory interface between a memory controller and a memory module, said method comprising:
a) programming a delay line of a data strobe with a delay value and programming a reference voltage with a voltage value;
b) writing a data bit pattern to said memory module wherein said data bit pattern is of a first plurality of unique data bit patterns;
c) reading back said data bit pattern and comparing a result thereof with said data bit pattern;
d) determining whether said memory module is in a passing state or an error state based on said comparing;
e) repeating said b)-d) with another data bit pattern of said first plurality of data bit patterns;
f) reprogramming said delay line with another delay value and reprogramming said reference voltage with another voltage value; and
g) repeating said b)-f).

2. The method of claim 1 further comprising populating a result matrix indicating said passing state and said error state of each data bit pattern with respect to each combination of said delay value and said voltage value.

3. The method of claim 1 further comprising resetting said memory module upon a determination of said error state.

4. The method of claim 1 further comprising:
determining a midpoint of determined passing states; and
establishing a comprehensive testing region around said midpoint.

5. The method of claim 4 further comprising:
repeating said b)-f) for each unique data pattern of a second plurality of unique data patterns on said comprehensive testing region; and
determining a final delay value and said voltage value.

6. The method of claim 1 wherein said data bit pattern comprises a victim bit and a plurality of aggressor bits.

7. The method of claim 1 wherein said plurality of unique data bit patterns are operable to cause inter-symbol interference and simultaneous switching output noise in said memory interface when written.

8. A computer readable storage medium having stored thereon, computer executable instructions that, if executed by a computer system cause the computer system to perform a method of training a command signal for a memory module, said method comprising:
a) programming a delay line of a data strobe with a delay value and programming a reference voltage with a voltage value;
b) writing a data bit pattern to said memory module wherein said data bit pattern is of a first plurality of unique data bit patterns;
c) reading back said data bit pattern and comparing a result thereof with said data bit pattern;
d) determining whether said memory module is in a passing state or an error state based on said comparing;
e) repeating said b)-d) with another data bit pattern of said first plurality of data bit patterns;
f) reprogramming said delay line with another delay value and reprogramming said reference voltage with another voltage value; and
g) repeating said b)-f).

9. The computer readable storage medium of claim 8 wherein said method further comprises populating a result matrix indicating said passing state and said error state of each data bit pattern with respect to each combination of said delay value and said voltage value.

10. The computer readable storage medium of claim 8 wherein said method further comprises resetting said memory module upon a determination of said error state.

11. The computer readable storage medium of claim 8 wherein said method further comprises:
determining a midpoint of determined passing states; and
establishing a comprehensive testing region around said midpoint.

12. The computer readable storage medium of claim 11 wherein said method further comprises:
repeating said b)-f) for each unique data pattern of a second plurality of unique data patterns on said comprehensive testing region; and
determining a final delay value and said voltage value.

13. The computer readable storage medium of claim 8 wherein said data bit pattern comprises a victim bit and a plurality of aggressor bits.

14. The computer readable storage medium of claim 8 wherein said plurality of unique data bit patterns are operable to cause inter-symbol interference and simultaneous switching output noise in said memory interface when written.

15. A system comprising:
a processor coupled to a computer readable storage media using a bus and executing computer readable code which causes the computer system to perform a method of training a command signal for a memory module, said method comprising:
a) programming a delay line of a data strobe with a delay value and programming a reference voltage with a voltage value;
b) writing a data bit pattern to said memory module wherein said data bit pattern is of a first plurality of unique data bit patterns;
c) reading back said data bit pattern and comparing a result thereof with said data bit pattern;
d) determining whether said memory module is in a passing state or an error state based on said comparing;
e) repeating said b)-d) with another data bit pattern of said first plurality of data bit patterns;
f) reprogramming said delay line with another delay value and reprogramming said reference voltage with another voltage value; and
g) repeating said b)-f).

16. The system of claim 15 further comprises populating a result matrix indicating said passing state and said error state of each data bit pattern with respect to each combination of said delay value and said voltage value.

17. The system of claim 15 wherein said method further comprises resetting said memory module upon a determination of said error state.

18. The system of claim 15 wherein said method further comprises:
determining a midpoint of determined passing states; and
establishing a comprehensive testing region around said midpoint.

19. The system of claim 18 wherein said method further comprises:
repeating said b)-f) for each unique data pattern of a second plurality of unique data patterns on said comprehensive testing region; and
determining a final delay value and said voltage value.

20. The system of claim 15 wherein said data bit pattern comprises a victim bit and a plurality of aggressor bits and wherein further said plurality of unique data bit patterns are operable to cause inter-symbol interference and simultaneous switching output noise in said memory interface when written.
